(19) United States
(12) Patent Application Publication
(10) Pub. No.: US 2005/0149386 A1
(43) Pub. Date: Jul. 7, 2005

(54) AUTHORIZING THIRD PARTY PARTICIPANTS

(75) Inventors: Vivian Agura, Wilton, CT (US); Chris J. Munkacsy, Hamilton, NJ (US); Trey Neemann, Glendale, AZ (US)

Correspondence Address: SNELL & WILMER;ONE ARIZONA CENTER, 400 EAST VAN BUREN, PHOENIX, AZ, 850040001, US

(73) Assignee: American Express Travel Related Services, Inc., New York, NY (US)

(21) Appl. No.: 10/707,661

(22) Filed: Dec. 30, 2003

(51) Int. Cl. G06F 17/60

(52) U.S. Cl. 705/14

(57) ABSTRACT

A system and method for authorizing third party participants to redeem and transact loyalty points earned by cardmembers.

### FIELD OF INVENTION

The present invention generally relates to loyalty points earned by cardmembers in a transaction card program, and more particularly, to a method and system for authorizing third party participants to redeem and transact loyalty points earned by cardmembers.

### BACKGROUND OF INVENTION

Traditional loyalty (e.g., incentive award, frequency reward, etc.) programs have existed for many years. Loyalty programs are typically implemented to help businesses develop and maintain participant loyalty and are often used as marketing tools to develop new clientele. A frequent flyer program is an example of a typical loyalty program, where the more the participant uses a particular airline or group of affiliated airlines, the more frequent flyer miles the participant earns. After accumulating frequent flyer miles, the participant may choose to redeem those miles for upgrades in service or free airline tickets. Various forms of these programs have developed over the years, ranging from programs such as “buy 9 get one 1” punch cards to more sophisticated credit card loyalty systems, where participants are awarded points for using a particular transaction card and/or for using a transaction card with particular merchants or vendors.

As competition in various markets increased, companies sought ways to expand loyalty programs to appeal to a broader cross-section of potential customers. One way this was accomplished was by developing strategic partnerships and affiliations with other business sectors. For example, hotel chains, airlines and rental car agencies developed loyalty program partnerships and affiliations; credit and transaction card companies also joined in to promote a more comprehensive and appealing loyalty program.

Online, interactive frequency and award redemption programs have been developed which immediately award and issue bonus points to a user's awards account in response to that user's online purchase of merchandise. In other words, submission of a purchase order form during an online session results in the calculation and addition of points to an enrolled user's account as well as the display of current account information. The user is then immediately permitted to redeem any or all of the award points in the user's account, including currently awarded points, in that same online session. These systems are specifically directed to the award and redemption of points for merchandise that may be offered directly by the account provider or its partners.

Other systems relate to incentive award programs which allocate monetary amounts of credit based on a participant's performance of a designated level of achievement. The monetary amounts can be withheld and/or adjusted by a sponsoring company. Although these systems allow for the crediting of a monetary value to a credit instrument, they are limited in that the participant is not able to interact over a computerized network so as to effect a real-time transaction or to effect a real time credit to a credit instrument.

Although many of these programs have been successful in developing customer loyalty and providing incentives for customers to act, they have not permitted customers to authorize additional participants to redeem loyalty points or otherwise transact with the loyalty points program. Therefore, a need exists in this industry for methods and system that facilitate the authorization of additional participates to redeem and transact the loyalty points of a primary cardmember.

### BRIEF DESCRIPTION OF DRAWINGS

A more complete understanding of the present invention may be derived by referring to the detailed description when considered in connection with the Figures, wherein like reference numbers refer to similar elements throughout the Figures, and:

FIG. 1 illustrates exemplary components of the present invention;

FIG. 2 illustrates a schematic overview of the exemplary phases of the present invention; and

FIGS. 3-6 are web page screen shots depicting an exemplary online embodiment of the present invention.

### DETAILED DESCRIPTION

In general, the present invention uniquely integrates a loyalty program and the financial transaction systems of a transaction card provider (“transaction system”) to more effectively use loyalty points to facilitate the redemption of loyalty points and other transactions involving the loyalty points. Specifically, the system and methods described herein allow a cardmember to authorize third party participants to redeem loyalty points (such as points awarded to a participant in the American Express Membership Rewards® Program) for various items (e.g., goods and services). This system not only provides a mechanism for redeeming loyalty points, but in certain embodiments, it also comprises other transactions involving loyalty points such as the purchase and reinstatement of loyalty points.

In addition, this system, in various embodiments, provides for at least three different authority levels: global assignment, functional assignment, and transactional assignment. A global assignment may indicate that the authorized third party can access and use any function or transaction available for the loyalty points. This authority is identical to that provided to the primary cardmember or owner of the account. A functional assignment may indicate that the authorized third party may use a specific function (e.g., redeeming points, buying back points, reinstating points, etc.) and any related transaction concerning the loyalty points for the account. A transactional assignment may indicate that the authorized third party may perform a specific type of transaction (e.g., redeeming points via points transfer) concerning the loyalty points for the account. These various authority levels will be described in more detail below. One skilled in the art will appreciate that any combination of the foregoing authority or any other types of authority may be combined or deleted to establish or change an authority level.

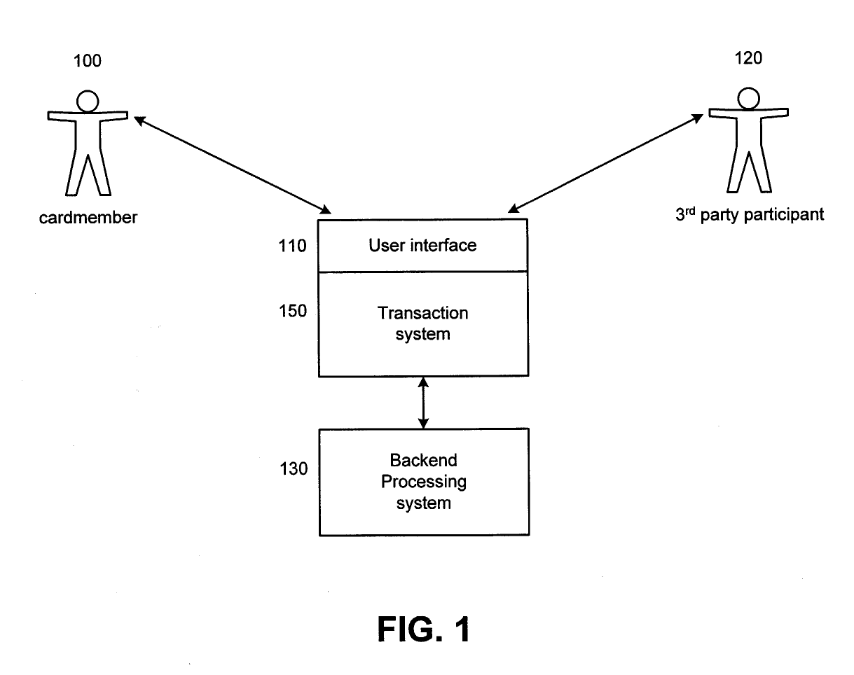

FIG. 1 illustrates exemplary components of the present invention. In accordance with one embodiment of the present invention, a primary cardmember 100 engages in an on-line session to facilitate authorizing a third party participant 120 to have access to the loyalty points of primary cardmember 100. The cardmember 100 utilizes on-line transaction system 150 to create a profile for the cardmember's account and to create an authorization access for the third party participant 120. The transaction system provides a user interface 110 that allows cardmembers to review information for their account and to create and modify their profile and various authorization access profiles. The backend-processing system 130 facilitates processing the creation and modification of the profiles and the various authorization access profiles. In accordance with other embodiments of the present inventions, channels other than an on-line session may be used by the primary cardmember for creating authorization access for third party participants. Examples of other channels include telephone, off-line computer systems, paper forms, face-to-face meetings, and the like. An exemplary system of the present invention may comprise various subsystems and applications. The exemplary components and users of the present invention are described below in more detail.

The primary cardmember 100, as used throughout this description, should be understood to mean any software, hardware, individual, business, government, non-profit organization and/or other entity that owns a transaction account wherein the transaction account may accumulate value. The value may include non-currency tender, such as loyalty points, that may be redeemed in various transactions. The primary cardmember 100 may also be known as and occasionally referred to herein as a “cardmember,” “cardholder,” “participant,” “user”, “customer,” or the like. In an exemplary embodiment, although the primary cardmember 100 may be the owner of an existing transaction card account, this is not required. Although the primary cardmember 100 will generally be enrolled in a loyalty program, such as the American Express Membership Rewards® Program, and will have accumulated loyalty points, this is also not required.

Although the value or non-currency tender referred to throughout this disclosure is frequently referred to as “loyalty points,” this invention is not so limited. It should be understood the loyalty points include any type of value or tender, a portion or all of which may be non-currency tender, or any other identifier of value or amount. For example, coupons, frequent flyer miles, incentive awards, frequency awards, electronic tokens, 401k accounts, individual retirement accounts (IRAs) and/or the like. One example of loyalty points contemplated by this invention is the membership reward points awarded to participants in the American Express Membership Rewards® program.

The third party participants 120 include any software, hardware, individual, business, government, non-profit organization, or other entity which may hold transaction cards associated with the primary cardmember's account or otherwise be associated with the primary cardmember's account. For example, in one embodiment, a third party participant 120 may be the spouse of the primary cardmember 100, wherein the spouse has a transaction card that is associated with the primary cardmember's account and use of the spouse's transaction card results in loyalty points being rewarded to the primary cardmember's account. In another embodiment, third party participants 120 may be employees of the primary cardmember, wherein each of the employees have a transaction card that is associated to the primary cardmember's account. In a further embodiment, third party participant 120 may be a dependent of the primary cardmember or other individual that has a transaction card that is associated to the primary cardmember's account. Although certain embodiments contemplate the third party participant 120 being related to primary cardmember 100, this is not required. Although referred to herein as “third party participant,” this term contemplates situations where any individual or party that is not the primary cardmember, and is not necessarily an individual, receives a form of authorization from the primary cardmember to redeem or otherwise transact loyalty points belonging to the primary card-member's account.

Moreover, the primary cardmember may desire to establish an associated account for use by the primary cardmember. As such, the primary cardmember may also be the “third party” participant. The primary cardmember may desire to establish another account for a variety of reasons, such as, for example, personal account and business account, accounts associated with his own different businesses, accounts based on different currencies, accounts used in certain regions, countries or states and/or the like.

The term “transaction” not only contemplates an exchange of items (e.g., goods or services) from one party to another which may be for value, but also the transferring of items from one party to another. This may be, for example, gifting of a currency value as described above or transferring loyalty currency from a first party account to another account (e.g., to a frequent flyer account of a particular airline). Additionally, transaction or transaction card numbers are account numbers that are used to facilitate any type of transaction. As used herein, a “transaction card” may include any account used for financial and/or loyalty transactions wherein the account may or may not be associated with a physical card, such as a charge card, credit card, debit card, smart card, bar-coded card, magnetic stripe card, account number, internet account, internet card, personal digital assistant account, digital wallet account, airline card, mall card, frequent shopper card, radio frequency identification “fob” device and/or the like.

Transaction system 150 may include a host server or other computing systems including a processor for processing digital data, a memory coupled to said processor for storing digital data, an input digitizer coupled to the processor for inputting digital data, an application program stored in said memory and accessible by said processor for directing processing of digital data by said processor, a display device coupled to the processor and memory for displaying information derived from digital data processed by said processor and a plurality of databases, said databases including client data, merchant data, financial institution data and/or like data that could be used in association with the present invention. As those skilled in the art will appreciate, user computer will typically include an operating system (e.g., Windows NT, 95/98/2000, Linux, Solaris, Windows XP, etc.) as well as various conventional support software and drivers typically associated with computers. User computer can be in a home or business environment with access to a network. In an exemplary embodiment, access is through the Internet through a commercially-available web-browser software package.

Communication among the primary cardmember 100, the transaction system 150, and the third party participants 120, or additional third parties (as may be contemplated by various embodiments) may take place over any computerized network via any suitable user interface system 110 that allow for the exchange of analog or digital information. As such, these systems may include, but are not limited to, telephone interactive voice response or operator-facilitated systems, online or offline computer networked systems using various transfer protocols, wireless devices, personal data assistants, interactive TV, broadband, ultrawide band devices, transponders and the like. In addition, the communication over a computerized network may be achieved using web services technology, including, but not limited to, SOAP, WSDL, UDDI, and the like. For example, the user interface system 110 may comprise web servers and applications configured to facilitate client/server communication over the internet via any wireless or wire-based system. It will be appreciated that many applications of the present invention could be formulated. One skilled in the art will appreciate that a interface system 110 may include any network or system for exchanging data or transacting business, such as the Internet, an intranet, an extranet, WAN, LAN, satellite or wireless communications, and/or the like. The primary cardmember 100 and third party participants 120 may interact with the transaction system 150 via any input device such as a telephone, keyboard, mouse, kiosk, personal digital assistant, touch screen, voice recognition device, transponder, biometrics device, handheld computer, personal data assistant (e.g., Palm Pilot®), cellular phone, web TV, web phone, blue tooth/beaming device and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, or the like. Moreover, although the invention uses protocols such as TCP/IP to facilitate network communications, it will be readily understood that the invention could also be implemented using IPX, Appletalk, IP-6, NetBIOS, OSI or any number of existing or future protocols. Moreover, the system contemplates the use, sale, exchange, transfer, or any other distribution of any goods, services or information over any network having similar functionality described herein.

The transaction system 150 may utilize any computer system for managing, tracking, and/or reporting loyalty program information. As previously described, the traditional loyalty systems allow participants to accumulate points in a loyalty program account and to then redeem points for merchandise. For example, the American Express Membership Rewards® system allows participants to accumulate points by using their transaction card (American Express® card) to make purchases or by shopping with affiliated merchants. The transaction system 150, as contemplated by the present invention, may be a stand-alone system or may be affiliated or integrated with other loyalty programs or transaction networks. The component parts of an exemplary transaction system 150 generally include computer server and database systems for processing and storing loyalty program account information.

The backend-processing system 130 is any suitable hardware and/or software configured to facilitate authorization of third party participants to use and transact loyalty points of a primary cardmember's account. In an exemplary embodiment, the backend-processing system 130 is configured to, inter alia, (1) receive requests to authorize a third party participant to redeem or otherwise use loyalty points of a primary cardmember's account, via a user interface system 110; (2) verify with the transaction system 150 that the specified third party participant has sufficient connection to the primary cardmember's account; (3) complete the authorization update for the third party participant; (4) provide to the primary cardmember 100, via user interface system 110, the updated authorization levels for various entities that are associated to the primary cardmember's account; and (5) use the authorization to process a transaction requested by a third party participant. The backend-processing system 130 may comprise various computer web and application servers, databases, routers, relays and the like in order to suitably process, route, and transmit data among, inter alia, the user interface system 110, transaction system 150, the primary cardmember 100, and third party participant 120.

User interface system 110 includes any software and/or hardware that is suitably configured to provide the various user interfaces of the present invention so that the user can interact with the transaction system.

Having described and defined exemplary components of the present invention, it should be appreciated that the present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, extensible markup language (XML), and Microsoft's Visual Studio .NET, with the various algorithms being implemented with any combination of data structures, objects, processes, routines or other programming elements. Further, it should be noted that the present invention might employ any number of conventional techniques for data transmission, signaling, data processing, network control, and the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development, database operations, and other functional aspects of the system (and components of the individual operating components of the systems) and method may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

This system may be integrated with other systems to better facilitate the redemption and other transactions involving loyalty points. For more information on loyalty systems, smart card systems, transaction systems, electronic commerce systems and digital wallet systems, see, for example, a system for using loyalty points as disclosed in Ser. No. 09/834,478; the Shop AMEX™ system as disclosed in Ser. No. 60/230,190 filed Sep. 5, 2000; a digital wallet system disclosed in U.S. Ser. No. 09/652,899 filed Aug. 31, 2000; a stored value card as disclosed in Ser. No. 09/241,188 filed on Feb. 1, 1999; a system for facilitating transactions using secondary transaction numbers disclosed in Ser. No. 09/800,461 filed on Mar. 7, 2001, and smart card systems disclosed in Ser. No. 60/232,040, filed on Sep. 12, 2000, all of which are herein incorporated by reference.

Referencing the online aspect of an exemplary embodiment of this invention, each user may be equipped with a computing system to facilitate online commerce transactions. The computing units may be connected with each other via a data communication network. The network is a public network and assumed to be insecure and open to eavesdroppers. In the illustrated implementation, the network is embodied as the internet. In this context, the computers may or may not be connected to the internet at all times. For instance, one user's computer may employ a modem to occasionally connect to the internet, whereas another user might maintain a permanent connection to the internet. It is noted that the network may be implemented as other types of networks, such as an interactive television (ITV) network.

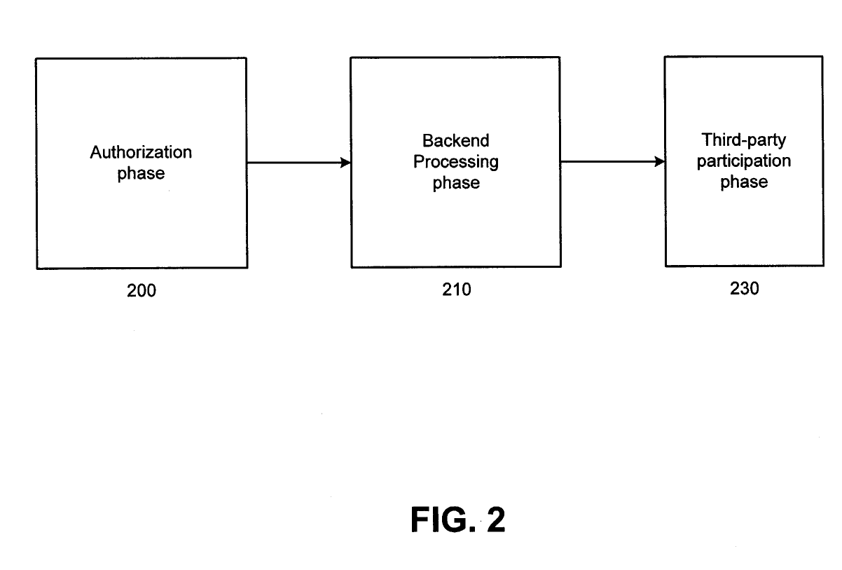

Turning now to the methods for redeeming loyalty points for non-tangible and tangible items, FIG. 2 illustrates three exemplary phases: (1) an authorization phase (step 200), (2) a backend-processing phase (step 210), and (3) a third party participation phase (step 230).

Authorization Phase:

The authorization phase 200 may include a primary card-member's successful registration and enrollment to use the system and method of the present invention. In general, primary cardmember 100 will have registered to participate in a loyalty program and will have accumulated at least some loyalty points. In an exemplary embodiment, primary cardmember 100 has a transaction card associated with a financial transaction account (e.g., Discover®card, American Express®card, etc.), wherein the system that supports the loyalty program associated with the card provider is what is referred to herein as the transaction system 150. Registration and enrollment processes are known in the art, and as such, will not be discussed in-depth herein. Although an exemplary embodiment contemplates the use of, and integration of a user's loyalty account and financial transaction account, other embodiments do not necessarily require this integration.

The authorization phase also may include the primary cardmember 100 viewing various items of information relating to the current authorization for the primary card-member's account. The user may also view specific authorization information about different third party participants as described below.

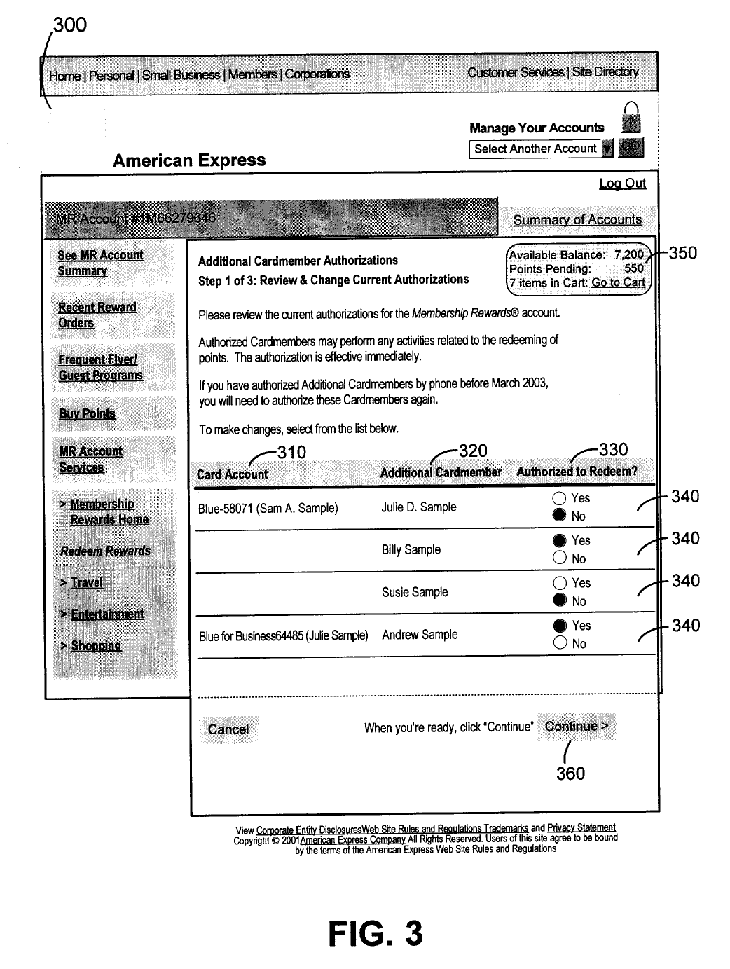

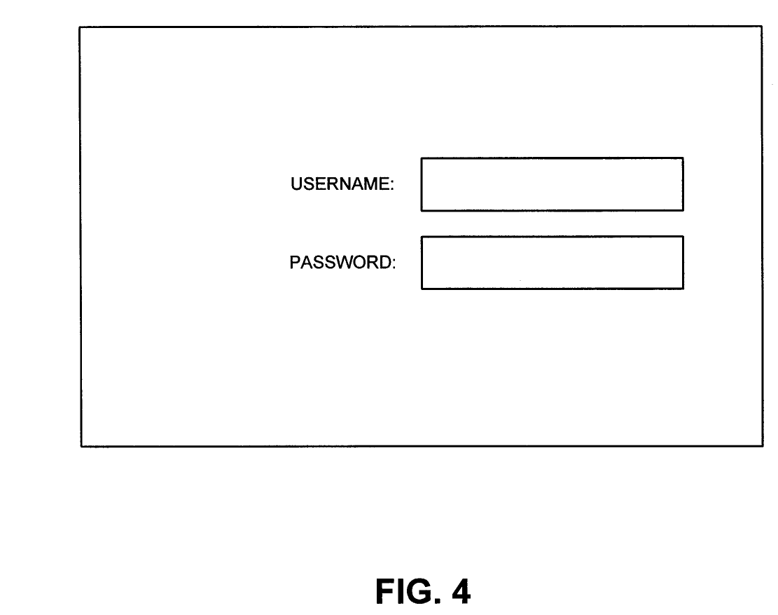

The authorization phase may be facilitated using an integrated (i.e., integrated with a shopping network) or stand-alone (i.e., not integrated with a shopping network) system. A stand-alone exemplary online embodiment is depicted in FIGS. 3-9. With additional reference to FIG. 1, these screen shots illustrate an exemplary embodiment of the present invention utilizing a user interface system 110 suitably configured with an appropriate web server system to facilitate online authorization of third party participants to redeem and otherwise transact with loyalty points. FIG. 3 illustrates an exemplary user interface 300 that provides specific information about third party participant's authorization for a primary cardmember's account. Here, primary cardmember 100 has requested to review the current third party authorization for their account. Desiring to review and change the third party authorization for their account, primary cardmember 100 has navigated to the transaction system 150 website and logged-in with appropriate authenticating information such as, for example, a username and password (FIG. 4). The primary card-member 100 may access the current third party authorization for their account and review and change the third party authorization as desired. The primary cardmember 100 may select one of the third party participant's records that are displayed and change the current authorization for that third party participant. It will be appreciated that the third party participant whose authorization is being modified has some known and/or defined relationship with the primary cardmember's account.

Continuing with FIG. 3, user interface 300 provides various types of information that facilitates the primary cardmember's review and decision as to whether to modify the third party participant's authorization for an account. Primary cardmember 100 is provided with information on the record 340 for each third party participant associated with their loyalty points account, including, for example, information on the card account 310, third party participant's name 320, and the authorization access 330 for that third party participant. In the illustrated example, the authorization access 330 includes information as to whether the third party participant is authorized to redeem loyalty points for the account. In other embodiments, the authorization access may include information as to whether the third party participant has global assignment, functional assignment, or transaction assignment for the account. For example, a global assignment may indicate that the third party participant can access and use any function or transaction available for the loyalty points. This authority is identical to that provided to the primary cardmember or owner of the account. A functional assignment may indicate that the third party participant may use a specific function (e.g., redeeming points, buying back points, reinstating points, etc.) and any related transaction falling under that authorized function concerning the loyalty points for the account. A transactional assignment may indicate that the authorized third party may perform a specific type of transaction (e.g., redeeming points via points transfer) concerning the loyalty points for the account. The primary cardmember may change the assignment level for a third party participant. If the assignment level is changed for a third party participant, then the database record for that third party participant is updated such that the viewed authorization access 330 will change accordingly. Thus, when that third party participant attempts to redeem or otherwise transact loyalty points belonging to the primary cardmember's account, the authorization access for that third party participant will be used to determine if the transaction can take place. For example, if the third party participant attempts to reinstate loyalty points, but the authorization access for that third party participant is only set to transaction assignment for a specific transaction unrelated to the reinstating of loyalty points, then the third party participant will not be allowed to reinstate loyalty points. However, if the third party participant has an authorization access set to global assignment, then the third party participant will be allowed to reinstate loyalty points.

The user interface system also provides an information section 350 that displays current information for the loyalty points associated with the primary cardmember's account. For example, information section 350 displays the available loyalty points balance, the currently loyalty points pending balance, and the number of items that have already been selected for redemption of the loyalty points.

Continuing with FIG. 3, the primary cardmember 100 may change the authorization access for various third party participants that are already associated with their account. In addition, the primary cardmember may add or delete third party participants from their account. As third party participants are added, the primary cardmember provides the authorization level for the new third party participant. In addition, when a third party participant is deleted from a primary cardmember's account, the authorization level for that deleted third party participant is also deleted from the primary cardmember's account. When the primary cardmember is finished reviewing and changing the third party authorizations, the primary cardmember may click on the continue button 360 of the user interface.

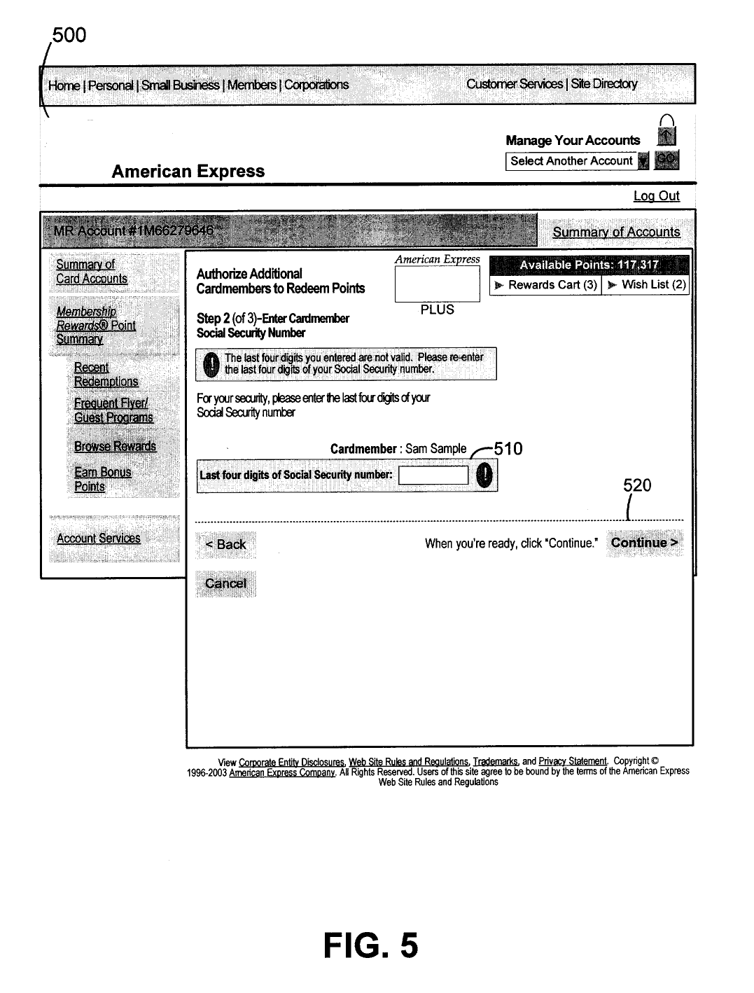

With reference to FIG. 5, user interface 500 illustrates information that may be requested from the primary cardmember to complete the authorization phase. In the illustrated example, the primary cardmember enters the last four digits of their social security number and then selects the continue button. This is an additional authentication step to ensure that it is the primary cardmember who is authorizing others to transact on their account.

Background Processing Phase:

Once the primary cardmember 100 has finished reviewing and indicating desired changes to the third party authorizations for their account, the primary cardmember may proceed to allowing the backend-processing system 130 to update the third party authorizations.

In one embodiment, upon completion of the authorization phase, the backend-processing system 130 processes each third party authorization change that was indicated by the primary cardmember during the authorization phase. However, the update may occur in real-time, batch mode and/or the like. The backend-processing system 130 is configured to, inter alia, (1) receive requests to authorize a third party participant to redeem or otherwise use loyalty points of a primary cardmember's account, via a user interface system 110; (2) verify with the transaction system 150 that the specified third party participant has sufficient connection to the primary cardmember's account; (3) complete the authorization update for the third party participant; and (4) provide to the primary cardmember 100, via user interface system 110, the updated authorization levels for various entities that are associated to the primary cardmember's account.

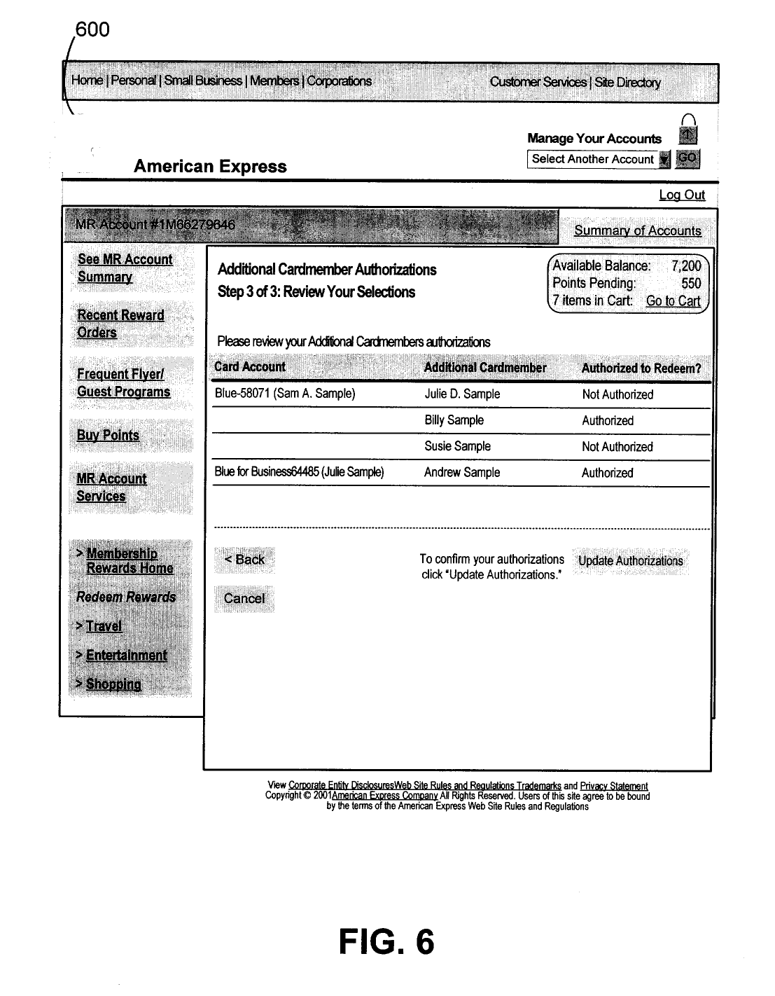

Before completing the authorization update, the primary cardmember may review the updated third party authorizations. With reference to FIG. 6, user interface 600 illustrates an exemplary user interface for this purpose.

Third Party Participation Phase:

The third party participation phase includes a third party participant's successful authorization to use the loyalty points of the primary cardmember's account. Depending on their authorization access, the third party participant may, for example, redeem loyalty points for items, buy back loyalty points, and/or reinstate loyalty points. It will be appreciated that by increasing the number of participants that can redeem and otherwise use loyalty points, the available pool of loyalty points may decrease in a shorter period of time, thus reducing the overall liability of the provider of the loyalty points system and also providing incentive to participants to accumulate additional points.

In the foregoing specification, the invention has been described with reference to specific embodiments. However, it will be appreciated that various modifications and changes can be made without departing from the scope of the present invention. The specification and figures are to be regarded in an illustrative manner, rather than a restrictive one, and all such modifications are intended to be included within the scope of present invention. For example, the steps recited in any of the method or process claims may be executed in any order and are not limited to the order presented.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. A method for facilitating operation of a loyalty points program having at least one primary cardmember, said primary cardmember having an account, the method comprising the steps of:
receiving information related to a cardmember profile for the account;
creating a cardmember profile for the account, wherein the profile comprises at least one third-party authorization, wherein each of said third-party authorization corresponds to a third-party participant and each third-party authorization specifies an authorization access for the third-party participant;
allowing each third-party participant to request a transaction with the loyalty points program according to their corresponding authorization access;
processing the transaction request; and
fulfilling the transaction request.

2. The method according to claim 1, wherein the authorization access comprises one of a global assignment, a functional assignment, and a transactional assignment.

3. The method according to claim 1, further comprising the step of comparing the requested transaction made by one of the third party participants to the authorization access for the third party participant.

4. The method according to claim 1, further comprising the steps of:
receiving, from one of the primary cardmembers, a request to change the authorization access for one of the third party participants associated with the primary cardmember's account; and
updating the cardmember profile for the primary cardmember's account to reflect the requested authorization access for the third party participant.

5. A system for operating a loyalty points program having at least one primary cardmember, each primary card-member having an account, the system comprising:
a transaction system component configured to manage, track, and report loyalty point information for the loyalty points program;
a backend processing system component configured to receive requests to authorize a third party participant to use the loyalty points of one of the primary cardmember's account, verify with the transaction system component that the third party participant has sufficient connection to the primary cardmember's account, process an authorization update for the third party participant, and provide the updated authorization access for the third party participant; and
a database configured to store loyalty point information.

6. A method for authorizing a third party participant to redeem and transact with a loyalty points program, the method comprising the steps of:
creating a profile for an account, wherein the account belongs to a cardmember; and
specifying an authorization access for the third party participant, wherein the authorization access comprises one of a global assignment, a functional assignment, and a transactional assignment.
